(19) United States
(12) Patent Application Publication
(10) Pub. No.: US 2024/0204825 A1
(43) Pub. Date: Jun. 20, 2024

(54) LOW COST MIMO CAPABLE DISTRIBUTED ANTENNA SYSTEM

(71) Applicant: Nextivity, Inc., San Diego, CA (US)

(72) Inventor: Michiel Petrus Lotter, San Diego, CA (US)

(21) Appl. No.: 18/527,148

(22) Filed: Dec. 1, 2023

Related U.S. Application Data
(60) Provisional application No. 63/429,719, filed on Dec. 2, 2022.

(51) Int. Cl. H04B 7/024; H04W 40/22; H04W 88/08

(52) U.S. Cl. CPC H04B 7/024; H04W 40/22; H04W 88/085

(57) ABSTRACT

A distributed antenna system includes a MIMO RF front end configured to receive signals from each of a number of donor antennas, each of the plurality of donor antennas providing donor antenna signals, and a plurality of signal processing subsystems connected with one of the donor antennas and configured to process signals received from the associated donor antenna via the MIMO RF front end. The system further includes one or more donor antenna signal distribution modules associated and connected with each of the plurality of signal processing subsystems, and a plurality of remote units, each of the plurality of remote units configured to receive signals from at least one donor antenna signal distribution module. The distributed antenna system employ a signal distribution strategy executed by the one or more signal distribution modules that routes individual donor antenna signals to individual remote units of the plurality of remote units.

### CROSS REFERENCE TO RELATED APPLICATIONS

### Background

The subject matter described herein relates to distributed antenna systems for inbuilding wireless communication systems, and more particularly to a low-cost multiple-antenna system.

In-building wireless coverage enhancement is often provided using either repeater systems or Distributed Antenna Systems (DAS). A DAS system may consist of a central unit, often called a Head-end or a Network Unit, and one or more remote units of coverage units. The complexity of both the head-end and the remote units are in large part determined by the number of different frequency bands that need to be boosted and the number of donor antenna signals that need to be relayed into the building. The larger the number of antennas, the more complex both the head-end and the remote. It is especially the complexity of the remote unit that is problematic as there are multiple remote units in a building and hence the cost of the overall solution grows rapidly with the number of remote units.

New wireless systems such as 5G New Radio (5GNR) include radio access technology systems that rely heavily on multiple antenna technology (MIMO) to improve coverage, capacity and throughput in a network. Therefore, distributed antenna systems supporting MIMO technology are typically more complex and expensive than systems that do not support or implement MIMO technology.

A basic diagram of a traditional DAS system is shown in FIG. 1. In the example, only two donor antennas are shown, but the number of donor antennas could be larger. The input signals from the donor antennas are typically processed using a MIMO RF Front and Transceiver sub-system. This process may for example convert the signal to baseband frequencies or to an Intermediate Frequency (IF). This signal is then processed by a signal processing sub-system that would typically prepare the MIMO signal to the remote units. When the MIMO signal arrives at the remote unit, the signal is converted into a RF signal at the same frequency as it was at the donor antennas, and a replica of the signals that arrived at all the donor antennas are transmitted either into co-axial cable distribution segments or into antennas.

### SUMMARY

This disclosure describes a cost-effective means to implement a distributed antenna system (DAS) configured for supporting multiple-input, multiple-output (MIMO) technology.

A distributed antenna system includes a MIMO RF front end configured to receive signals from each of a number of donor antennas, each of the plurality of donor antennas providing donor antenna signals, and a plurality of signal processing subsystems connected with one of the donor antennas and configured to process signals received from the associated donor antenna via the MIMO RF front end. The system further includes one or more donor antenna signal distribution modules associated and connected with each of the plurality of signal processing subsystems, and a plurality of remote units, each of the plurality of remote units configured to receive signals from at least one donor antenna signal distribution module. The distributed antenna system employ a signal distribution strategy executed by the one or more signal distribution modules that routes individual donor antenna signals to individual remote units of the plurality of remote units.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a low cost MIMO-capable distributed antenna system that receives and processes signals from multiple donor antennas for transmission to multiple single-input, single-output (SISO) remote units, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current state of the art of a distributed antenna system (DAS); and

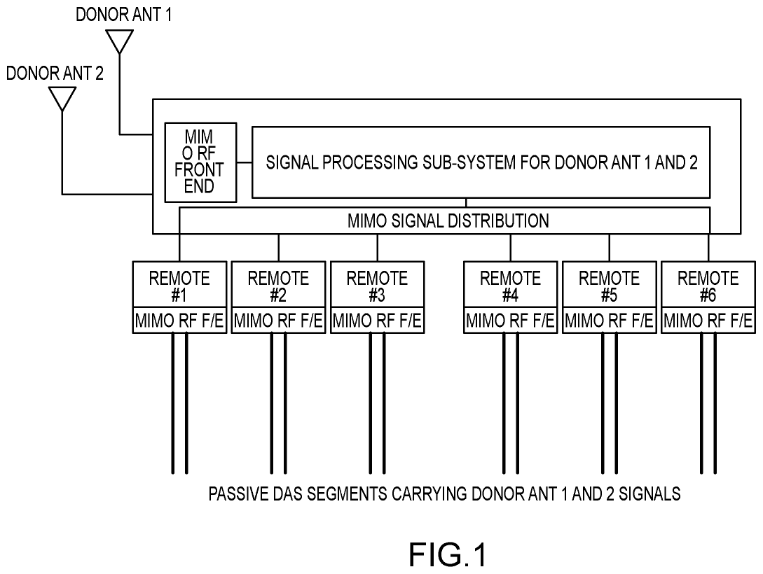

FIG. 2 shows a diagram illustrating aspects of a system showing features consistent with implementations of the current subject matter.

Like reference symbols in the various drawings indicate like elements.

### DETAILED DESCRIPTION

This document describes to a low-cost multiple-antenna system for distributed antenna systems for inbuilding wireless communication systems.

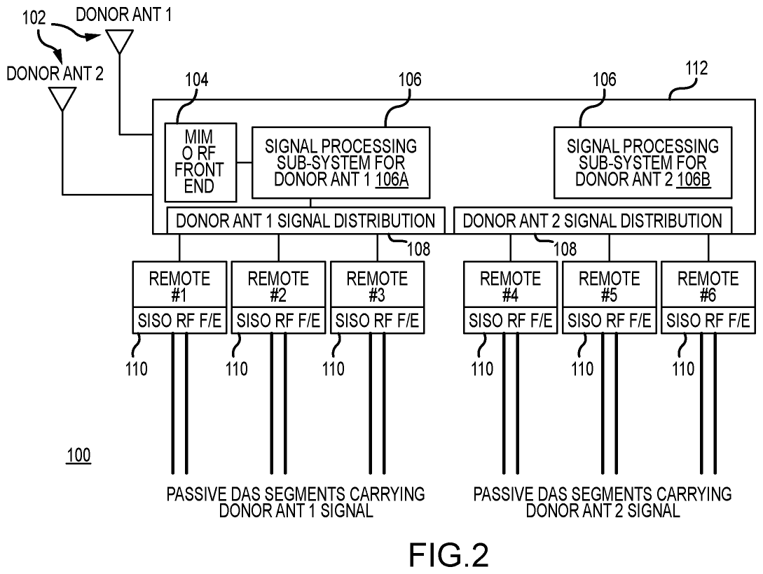

FIG. 2 illustrates a low-cost multiple-antenna system 100. Instead of processing the signals from all the donor antennas together, the signals from the various donor antennas 102 are split up and processed independently. Subsequently, the signals from the donor antennas 102 are distributed to individual remote units as single signals, not as combined multi-donor antenna signals.

In some implementations, and as shown in FIG. 2, a distributed antenna system 100 (i.e., shown with two donor antennas 102, donor antenna 1 and donor antenna 2) is illustrated. The system can include a MIMO RF front end 104 to receive signals from each donor antenna 102. The system further includes separate signal processing subsystems 106 for each different donor antenna inputs, such as signal processing subsystem 106A for donor antenna 1 and signal processing subsystem 106B for donor antenna 2. Each signal processing subsystem 106 is configured to process signals received from the donor antennas via the MIMO RF front end 104. One or more donor antenna signal distribution modules 108 are associated and connected with each of the signal processing subsystems.

The system 100 includes a number of remote units 110, shown in FIG. 2 as Remote #1 . . . Remote #6, etc., although any number of remote units 110 can be employed and in communication with a signal distribution module. In some preferred implementations, the remote units are distributed within a building, or about another defined area or structure. To alleviate the need for too many remote units, which, as described above, greatly increases the costs and forces the system into a MIMO RF F/E paradigm, the system can employ a signal distribution strategy that routes individual donor antenna signals to individual remote units.

Each of the remote units 110 in the system 100 employs a single-input, single-output (SISO) RF front end (F/E). The remote units 110 are grouped and connected with individual signal processing subsystems 108, for a grouped SISO RF F/E, where the signal is converted into an RF signal at the same frequency as it was at the donor antennas 102 and a replica of the signals that arrived at each of the donor antennas 102 associated with each grouping of the remote units 110 are transmitted either into cable distribution segments (such as co-axial, optical or the like) or into transmission antennas.

In some implementations, the system 100 shown in FIG. 2 includes a signal processing system 112, which can be integrated with each or all of signal processing subsystems 106 or a separate processor, and which is configured to determine gain values to be applied to signals being transmitted and received from each donor port by combining gain calculations from each of the separate signal processing subsystems.

Accordingly, instead of processing the signals from all the donor antennas 102 together, as in the current state of the art, the signals from the various donor antennas 102 are split up and processed independently. Then, the signals from the donor antennas are distributed to individual remote units 110 as single signals, in SISO mode, not as combined multi-donor antenna signals. Therefore, the system can provide individual passive DAS segments carrying separate donor antenna signals.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A distributed antenna system comprising:
a MIMO RF front end configured to receive signals from each of a plurality of donor antennas, each of the plurality of donor antennas providing donor antenna signals;
a plurality of signal processing subsystems, each signal processing subsystem being connected with one of the plurality of donor antennas via an input and configured to process signals received from the associated donor antenna via the MIMO RF front end;
one or more donor antenna signal distribution modules associated and connected with each of the plurality of signal processing subsystems; and
a plurality of remote units, each of the plurality of remote units being configured to receive signals from at least one donor antenna signal distribution module;
wherein the distributed antenna system is configured to employ a signal distribution strategy executed by the one or more signal distribution modules that routes individual donor antenna signals to individual remote units of the plurality of remote units.

2. The distributed antenna system in accordance with claim 1, wherein the remote units are distributed within a building.

3. The distributed antenna system in accordance with claim 1, wherein each of the plurality of remote units employs a single-input, single-output (SISO) RF front end.

4. The distributed antenna system in accordance with claim 3, wherein the plurality of remote units are grouped and connected with individual signal processing subsystems for a grouped SISO RF front end.

5. The distributed antenna system in accordance with claim 4, wherein the donor antenna signals are converted into an RF signal at the same frequency as at the plurality of donor antennas.

6. The distributed antenna system in accordance with claim 5, wherein a replica of the donor antenna signals that arrived at each of the plurality of donor antennas associated with each grouping of the remote units are transmitted either into cable distribution segments or into transmission antennas.
